(19) United States
(12) Patent Application Publication
(10) Pub. No.: US 2011/0294660 A1
(43) Pub. Date: Dec. 1, 2011

(54) REUSABLE HEAVY METAL REMOVER AND FABRICATION METHOD THEREOF

(76) Inventors: Hye Young KOO, Jeollabuk-Do (KR); Jun Kyung KIM, Seoul (KR); Won San CHOI, Jeollabuk-Do (KR); Ha Jin LEE, Seoul (KR)

(21) Appl. No.: 12/896,178

(22) Filed: Oct. 1, 2010

(30) Foreign Application Priority Data
May 27, 2010 (KR) 10-2010-0049856

(51) Int. Cl. B01J 20/26; B01J 20/06

(52) U.S. Cl. 502/402; 502/406

(57) ABSTRACT

A heavy metal remover of a core-shell structure comprises a core including carbon nanotubes (CNT) that can aggregate and scatter in a reversible manner, and a shell including iron oxide. A method for fabricating a heavy metal remover of a core-shell structure comprises (a) preparing a carbon nanotube (CNT) aqueous solution where acid-treated CNTs have dissolved, (b) mixing the CNT aqueous solution with an aqueous solution of polymer template particles, thereby forming a CNT layer on the surface of the template particles, (c) mixing the solution having undergone the step (b) with a polymer electrolyte having positive charges, thereby forming a polymer layer on an outer surface of the CNT layer, (d) adding FeSO₄, Fe₂(SO4)₃ or a mixture thereof to the solution having undergone the step (c), and stirring the solution, thereby including iron oxide in the polymer layer, (e) separating particles from the solution having undergone the step (d), and (f) removing the template particles by heat-treating the particles having been separated in the step (e). The method for removing heavy metal ions is capable of removing heavy metal ions by adsorbing the heavy metal ions into the CNTs of the core, with using the heavy metal remover of a core-shell structure.

### CROSS-REFERENCE TO A RELATED APPLICATION

Pursuant to 35 U.S.C. §119(a), this application claims the benefit of earlier filing date and right of priority to Korean Application 10-2010-0049856, filed on May 27, 2010, the content of which is incorporated by reference herein in its entirety.

### BACKGROUND OF THE INVENTION

1. Field of the Invention

The present invention relates to a heavy metal remover, and particularly, to a reusable heavy metal remover capable of removing heavy metal ions is adsorbed onto the remover and capable of being reused after being separated from a solution, a fabrication method thereof, and a method for removing heavy metal ions using the same.

2. Background of the Invention As a heavy metal remover, most frequently used is a material which forms complex compounds with heavy metal ions and then is separated from a solution after forming sediment, so as to prevent the heavy metal ions adsorbed thereto from being desorbed therefrom.

Generally, chelating polymer compounds react with heavy metal ions more strongly and stably than complex compounds with heavy metal ions. Accordingly, research on methods for effectively removing heavy metal ions with using the cheating polymer compounds is actively ongoing, recently.

However, in case of using only a bulk material capable of adsorbing heavy metal ions, the following problems may occur.

Firstly, it is difficult to selectively process a byproduct having adsorbed heavy metal ions.

Secondly, heavy metal ions adsorbed into the bulk material are not desorbed from the bulk material due to strong bonding therebetween. This may cause the bulk material used once as a heavy metal remover not to be used again.

### SUMMARY OF THE INVENTION

Therefore, an object of the present invention is to provide a heavy metal remover capable of effectively removing heavy metal ions by introducing a heavy metal absorbent into a shell when removing the heavy metal ions by a core-shell structure not by a bulk material, and capable of selectively separating the heavy metal remover from a solution after adsorbing the heavy metal ions by introducing desired functional groups to the shell.

Another object of the present invention is to provide a structure to allow a heavy metal remover to be reused by separating heavy metal ions from the heavy metal remover.

More concretely, the purpose of the present invention is to provide a structure to implement a reusable heavy metal remover capable of allowing a heavy metal remover to be regenerated to be reused, by selectively separating the heavy metal remover having heavy metal ions adsorbed thereto from a solution, and by desorbing the adsorbed heavy metal ions from the heavy metal remover, a fabrication method thereof, and a method for removing heavy metal ions using the same.

A heavy metal remover of a core-shell structure may comprise a core of carbon nanotubes (CNTs) which can reversibly aggregate and scatter, and a shell including iron oxide.

To achieve these and other advantages and in accordance with the purpose of the present invention, as embodied and broadly described herein, there is provided a method for fabricating a heavy metal remover of a core-shell structure, the method comprising: (a) preparing a carbon nanotube (CNT) aqueous solution where acid-treated CNTs have dissolved; (b) mixing the CNT aqueous solution with an aqueous solution of polymer template particles, thereby forming a CNT layer on a surface of the template particles; (c) mixing the solution having undergone the step (b) with a polymer electrolyte having positive charges, is thereby forming a polymer layer on an outer surface of the CNT layer; (d) adding FeSO₄, Fe₂(SO4)₃ or a mixture thereof to the solution having undergone the step (c), and stirring the solution, thereby including iron oxide in the polymer layer; (e) separating particles from the solution having undergone the step (d); and (f) removing the template particles by heat-treating the particles having been separated in the step (e).

According to another aspect of the present invention, there is provided a method for fabricating a heavy metal remover of a core-shell structure, the method comprising: (a) preparing a carbon nanotube (CNT) aqueous solution where acid-treated CNTs have dissolved; (b) mixing the CNT aqueous solution with an aqueous solution of polymer template particles, thereby forming a CNT layer on a surface of the template particles; (c) mixing the solution having undergone the step (b) with a polymer electrolyte having positive charges, thereby forming a polymer layer on an outer surface of the CNT layer; (d) chemically processing the solution having undergone the step (c), thereby removing the template particles; (e) adding FeSO₄, Fe₂(SO4)₃ or a mixture thereof to the solution having undergone the step (d), and stirring the solution, thereby including iron oxide in the polymer layer; (f) separating particles from the solution having undergone the step (e).

In the method for removing heavy metal ions according to the present invention, a heavy metal remover of a core-shell structure may be used to remove heavy metal by adsorbing heavy metal ions to carbon nanotubes (CNTs) of a core.

The reusable heavy metal remover according to the present invention may have the following advantages.

Firstly, the heavy metal remover having heavy metal ions adsorbed thereto may be selectively and easily separated from a solution by applying a magnetic field thereto since the heavy metal remover comprises a polymer layer including iron oxide.

Secondly, the heavy metal remover may be reused by being regenerated through either mild acid treatment or sonication, or through both of the two processes for scattering aggregated CNTs of a core.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view showing a method for fabricating a heavy metal remover through consecutive coating of polymer electrolytes and nanoparticles and final heat treatment (calcination);

FIG. 2 shows scanning electron microscope (SEM) images of a carbon nanotube (CNT) core-iron oxide shell structure according to each step;

FIG. 3 shows transmission electron microscope (TEM) images of a carbon nanotube (CNT) core-iron oxide shell structure, and graphs representing energy is dispersive X-ray spectroscopy (EDX) analysis;

FIG. 4 shows graphs representing absorption/desorption ratios of lead (Pb) and chromium (Cr) per heavy metal remover according to the present invention; and

FIG. 5 shows electron microscope images of gold (Au)/CNTs composite core-silica shell according to each step, and shows a Raman graph of CNTs.

### DETAILED DESCRIPTION OF THE INVENTION

Description will now be given in detail of the present invention, with reference to the accompanying drawings.

For the sake of brief description with reference to the drawings, the same or equivalent components will be provided with the same reference numbers, and description thereof will not be repeated.

A heavy metal remover according to the present invention may comprise a core of carbon nanotubes (CNTs) which can reversibly aggregate and scatter, and a shell including iron oxide. The CNTs form a core at an inner space of the shell. If the CNTs aggregate with one another due to absorption of heavy metal ions, etc., the inner space of the shell may not be filled. On the other hand, if the CNTs scatter, the inner space of the shell may be completely filled with the CNTs.

The core may further include metallic particles. Owing to these metallic particles, additional functions as well as a specific function of the heavy metal remover may be implemented. As the metallic particles, may be used at least one material selected from a group consisting of gold, silver, platinum and copper. The gold, silver and copper may serve to enhance electrical conductivity and a photoactive characteristic, whereas the platinum may perform a catalytic function.

The shell including iron oxide may have a multi-layered structure. As each layer is provided with other component rather than the iron oxide, the heavy metal remover may perform other functions. For instance, the shell may be fabricated to have a multi-layered structure including each kind of polymers, metallic nanoparticles, organic fluorescent materials, bio-materials, etc.

A method for fabricating a heavy metal remover according to the present invention comprises: (a) preparing a carbon nanotube (CNT) aqueous solution where acid-treated CNTs have dissolved, (b) mixing the CNT aqueous solution with an aqueous solution of polymer template particles, thereby forming a CNT layer on the surface of the template particles, (c) mixing the solution having undergone the step (b) with a polymer electrolyte having positive charges, thereby forming a polymer layer on an outer surface of the CNT layer, (d) adding FeSO₄, Fe₂(SO4)₃ or a mixture thereof to the solution having undergone the step (c), and stirring the solution, thereby including iron oxide in the polymer layer; (e) separating particles from the solution having undergone the step (d); and (f) removing the template particles by heat-treating the particles having been separated in the step (e).

The template particles in step (b) are introduced so as to form CNTs, and may be removed through sonication after forming the polymer layer including an ion oxide. Alternatively, the template particles may be removed by a chemical process after forming the polymer layer on an outer surface of the CNT layer.

The CNTs undergoes acid-treatment in step (a), so that the CNTs can be evenly distributed to the aqueous solution.

The method for fabricating a heavy metal remover according to the present invention may further comprise, before the step (b), (a′) adding metallic particles to the aqueous solution of polymer template particles, thereby distributing the metallic particles to the surface of the polymer template particles.

The polymer template particles of the step (b) may be at least one selected from a group consisting of polystyrene, melamine formaldehyde, polymethyl methacrylate (PMMA) and silica. And, the polymer electrolyte having positive charges may be at least one selected from a group consisting of poly(allylamine hydrochloride), polydiallyldimethylammonium chloride, and polyethylenimine.

In step (b), the CNT layer may be effectively formed on the surface of the template particles by electrostatic coupling between template particles in the template particle aqueous solution having positive charges and CNTs in the CNT aqueous solution having negative charges. Under the electrostatic coupling, the CNT layer may be easily coupled to the surface of the template particles by electrostatic attraction, and the CNTs having negative charges may be uniformly distributed on the template particles due to a repulsive force therebetween thus to form a layer of a uniform thickness.

Multi-layered polymer layers may be formed by repeating the step (c). This multi-layered polymer layers may be effective to include a component having a specific function therein, and may be prevented from having inter-layer interference due to reactions therebetween.

The heat-treatment (heat treatment) in step (f) may be performed at a temperature more than 500° C. Here, conditions for the heat-treatment are minimum conditions for completely removing MF template particles. It is preferable to perform the heat-treatment at a temperature more than 500° C. for at least 6 hours.

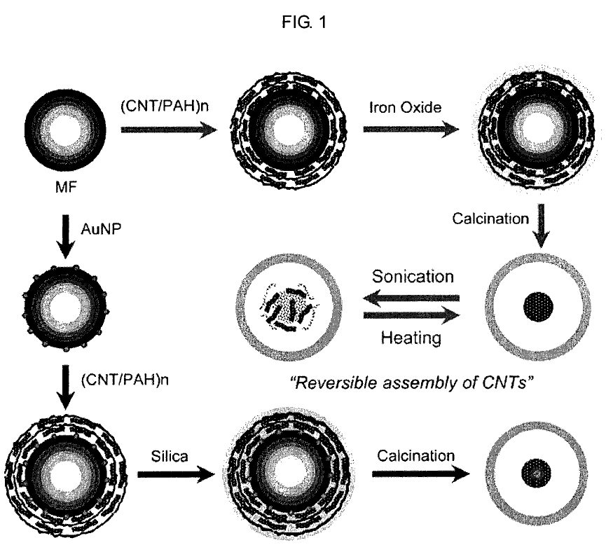

FIG. 1 is a schematic view showing a method for fabricating a heavy metal remover through consecutive coating of polymer electrolytes and nanoparticles and final heat-treatment.

The fabrication method may be implemented by a first process toward the right side from the left upper side, and a second process toward the down side from the left upper side. Here, the second process indicates additionally adding metallic particles to a core.

A carbon nanotube (CNT) layer and a polymer layer are formed on template particles, and iron oxide particles are synthesized thereon through introduced precursor materials and hydrolysis. Then, the resulting particles undergo heat-treatment at a temperature more than 500° C. for 6 hours. As a result, the template particles gradually disappear, and the CNTs gradually aggregate to form one lump.

During the heat-treatment, the CNTs are aggregated into a structure of a set by heat. Then, the shell consisting of various types of iron oxide such as goethite, magnetite, and hematite is transformed to the hematite, the most stable iron oxide.

Through the synthesis, a core-shell structure having a novel function may be fabricated by applying various materials. For instance, an Au/CNTs composite core-silica shell structure may be fabricated by using gold nanoparticles, carbon nanotubes, and silica (refer to the process toward the down side of FIG. 1).

According to the present invention, heavy metal may be removed with using the heavy metal remover by adsorbing heavy metal ions to CNTs of a core.

In a case that the heavy metal remover having heavy metal ions adsorbed thereto is mixed with other components, a magnetic field is applied to the heavy metal remover. This may allow the heavy metal remover to be effectively separated from a solution, because iron oxide is included in the shell.

The heavy metal remover having heavy metal ions adsorbed thereto may be reused by being regenerated through either mild acid treatment or sonication, or through both of the two processes for discharging out the heavy metal ions by scattering aggregated CNTs.

The heavy metal ions adsorbed to the heavy metal remover are easily desorbed through exposure to an acid solution. The reason is because the heavy metal ions adsorbed to carboxylic groups on the surface of the CNTs perform ion exchanges with protons inside the acid solution, and then are desorbed from the CNTs.

Hereinafter, a preferred embodiment of the present invention will be explained in more detail according to each step. The following embodiment is disclosed so as to explain the present invention more specifically, but the present invention is not limited to this.

A TEM/EDX analysis was performed under a voltage of 200 kV with a JEM-2200 FS microscope made by JEOL Corporation. UHR FE-SEM image was observed by S-5500 and S-4700 microscopes made by Hitachi. A Raman analysis was performed by a Nanofinder 30 made by Tokyo Instrument Corporation. An XRD analysis was performed by an X-ray diffractometer made by Japanese Rigaku Corporation. An ICP-MS analysis was performed by a model of 7500a made by USA Agilent Corporation. BET measurements were performed by a particle size analyzer, UPA-150. And, an FT-IR analysis was performed by Nicolet iS10 made by USA ThermoFisher Scientific Corporation.

As the CNTs of the present experiments, were used multi-wall CNTs (‘MWCNT’) produced by Hanwha Nanotech Corporation. 2.3 g of MWCNTs were dissolved in 50 ml of 60% HNO₃ solution by weight. For effective scattering, the mixture was sonicated for 30 minutes, and was stirred for 24 hours.

The mixture was diluted by 200 ml of purified water, and was filtered by using a PVDF membrane having 0.45 μm. Then, the mixture was dried for 24 hours in a vacuum oven after being washed a plurality of times by purified water.

1.4 ml of aqueous solution including acid-treated CNTs was mixed with 0.13 ml of 10% melamine formaldehyde (MF) solution by weight, the MF having an average particle size of 1.85 μm. Then, the mixture was stirred for one hour to induce a reaction. After completing the reaction, non-reacted materials were removed by a centrifugal separator, and then generated particles were washed three times by purified water.

The resulting material was put into 1.4 ml (2 mg/mL) of poly(allylamine hydrochloride) solution (hereinafter, will be referred to as ‘PAH’ solution), then was reacted for 15 minutes, and was washed to form a PAH layer.

For generation of iron oxide nanoparticles, FeSO₄ (1.9×10⁻⁵ M) solution was mixed with 1.4 ml of Fe₂(SO₄)₃ (2.1×10⁻⁵ M) solution. The mixture was stirred for 6 hours to perform a reaction. As oxygen included in the air is introduced into the mixture by the stirring, hydrolysis was performed in a polymer layer to form iron oxide nanoparticles.

The iron oxide nanoparticles were washed three times by purified water, and final composite particles synthesized so that CNTs of a core can be aggregated were heat-treated (calcined) for 6 hours at a temperature of 500° C. During this process, melamine formaldehyde constituting template particles was is decomposed, and the CNTs of the core had an aggregated structure.

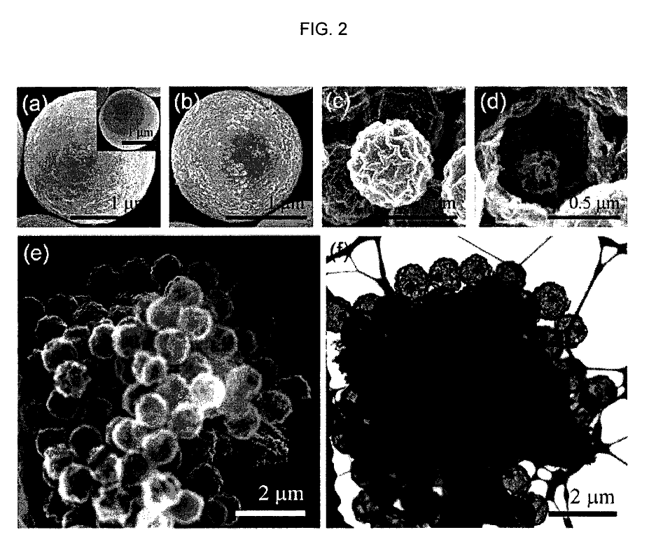

FIG. 2 shows scanning electron microscope (SEM) images of a carbon nanotube (CNT) core-iron oxide shell structure according to each step. More concretely, FIG. 2(a) shows an image of an MF particle on which CNTs and PAH have been coated, FIG. 2(b) shows an image of a particle implemented as a CNT layer, and a PAH layer including iron oxide are sequentially formed on an MF particle, and FIG. 2(c) shows an image of a CNT core-iron oxide shell of which template particles have been removed by heat-treatment. FIG. 2(d) shows that CNTs are aggregated in a cracked shell, FIG. 2(e) is a ultra high resolution field emission-scanning electron microscopy (UHR FE-SEM) image of the CNT core-iron oxide shell, and FIG. 2(f) is a ultra high resolution field emission transmission electron microscopy (UHR FE-TEM) image of the CNT core-iron oxide shell.

Firstly, a smooth MF particle is prepared. Then, a CNT layer, a polymer layer and iron oxide particles are synthesized. As a result, a CNT core-iron oxide shell having a gradually increased surface roughness is implemented. After completing heat-treatment, a walnut-shaped core-shell structure is implemented. Here, finally synthesized particles have a size corresponding to about 54% of a size of the original template particles, resulting from contraction due to heat. It can be seen that CNTs are aggregated in the form of a lump at an inner side of a cracked shell of FIG. 2(d).

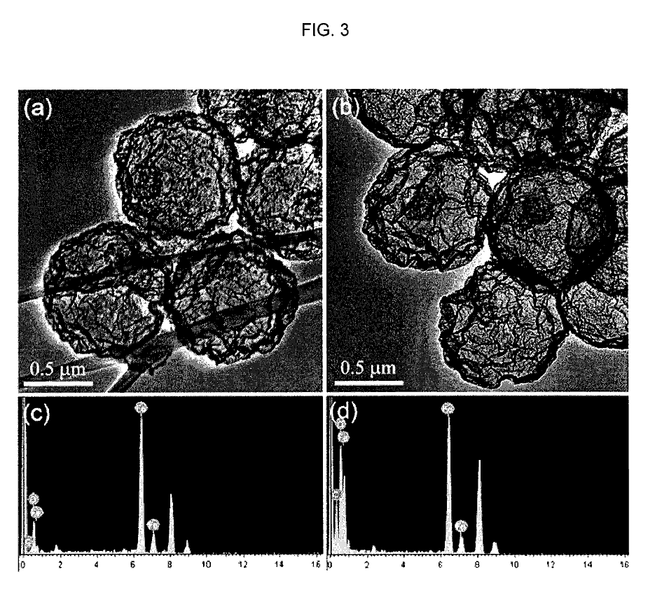

FIG. 3 shows transmission electron microscope (TEM) images of a carbon nanotube (CNT) core-iron oxide shell structure, and graphs representing energy dispersive X-ray spectroscopy (EDX) analysis. FIGS. 3(a) shows TEM images of scattered CNTs and 3(c) show a result after sonication. FIGS. 3(b) shows TEM images of aggregated CNTs, and 3(d) shows a result after heat-treatment.

In order to scatter aggregated CNTs, the aggregated CNTs are dispersed in a solvent to undergo sonication. In case of CNTs aggregated in a shell, the aggregated CNTs undergoes sonication in a mild acid solution (nitric acid:sulfuric acid=3:1) for 20 minutes, thereby scattering the aggregated CNTs in an iron oxide shell. The CNTs scattered in the shell can be aggregated through later heat-treatment, and the conglomeration and scattering can be reversibly induced.

The conglomeration and scattering of CNTs may be checked by a plurality of analysis methods. One of the plurality of analysis methods is a method for measuring a specific surface area. A specific surface area of aggregated CNTs is about 200±4 m²/g, whereas a specific surface area of scattered CNTs is about 270±2 m²/g.

Hereinafter, will be explained absorption and desorption tests for heavy metal ions so as to check a performance of the heavy metal remover according to the present invention.

For the absorption and desorption test for heavy metal ions, Pb(NO₃)₂ was used as lead, and KwCr₂O₇ was used as chromium. Initial concentrations of the lead and chromium were 17.1 mg/L and 11.4 mg/L at pH of 5.

0.009 g of the heavy metal remover according to the present invention was put into 25 ml of a solution, and the mixture was stirred. After a predetermined time (10 min, 20 min, 40 min, 80 min and 2H) has lapsed, the heavy metal remover was separated from the solution, and the amount of the lead or the chromium remaining in the solution was measured by using an inductively coupled plasma mass spectroscopy (ICPMS).

An absorption amount for heavy metal ions is calculated as the following equation.

qₑ=(Cₒ-Cₑ)V/m

Here, the ‘qₑ’ indicates an equilibrium concentration of heavy metal ions on the heavy metal remover, ‘Cₒ’ indicates an initial concentration of a solution of heavy metal ions, ‘Cₑ’ indicates an equilibrium concentration of heavy metal ions, ‘m’ indicates a mass of an absorbent, and ‘V’ indicates a volume of heavy metal ions.

In an equilibrium state, a concentration of the Pb ions remaining in the solution was measured so as to obtain an absorption capacity of the Pb ions.

In order to induce desorption of heavy metal ions from the heavy metal remover, for separation the heavy metal remover having the heavy metal ions adsorbed thereto from a solution, the heavy metal remover was filtered by a PVDF membrane filter. Then, the filtered heavy metal remover was dried at a room temperature, and was scattered to 25 ml of the solution through sonication.

A concentration of the Pb ions desorbed from the heavy metal remover after reaching the equilibrium state was measured.

The absorption and desorption tests were repeated five times so as to check whether the heavy metal remover can be reused or not.

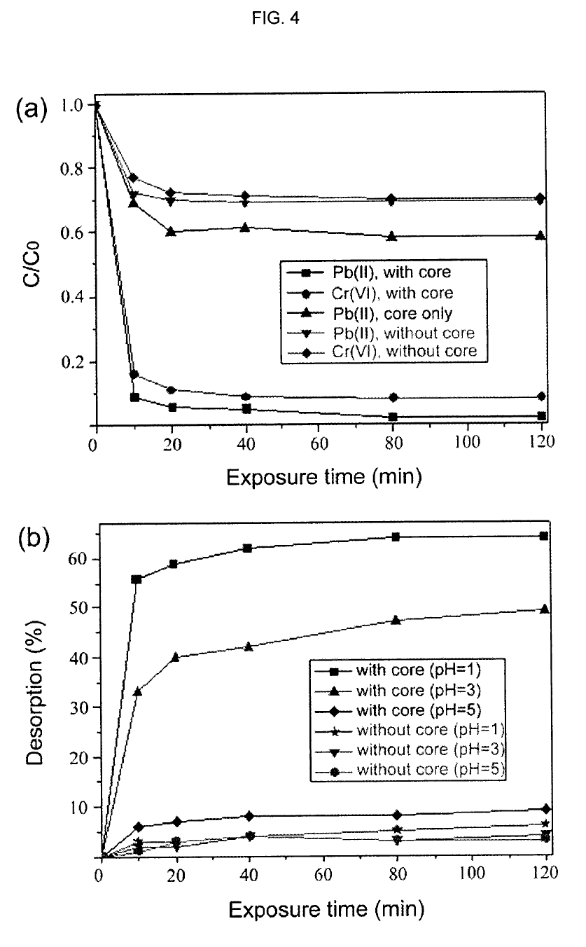

FIG. 4 shows graphs representing absorption/desorption ratios of lead (Pb) and chromium (Cr) per the heavy metal remover according to the present invention. FIG. 4(a) represents an absorption ratio of heavy metal ions to a shell according to whether a core of CNTs exists or not, and FIG. 3(b) represents a desorption ratio of Pb ions from a shell according to whether a core of CNTs exists or not at various pHs. Initial concentrations of the Pb and Cr were 17.1 and 11.4 mg/L.

When exposed to CNT core-ion oxide shell particles, most of the Pb and Cr ions were rapidly removed for a short time within 10 minutes. 46.6 mg/g of the Pb ions were removed, and 29.16 mg/g of chromium were removed. These removed amounts were much larger than the conventional iron oxide-based heavy metal remover.

The heavy metal remover having adsorbed the heavy metal ions was tested whether it can be reused through acid-treatment. After the test, it was checked that the heavy metal remover can be reused by desorption of the heavy metal ions. In case of hematite, the conventional heavy metal remover, compounds are formed by strong bonding. Accordingly, heavy metal ions having been adsorbed to a heavy metal remover can not be desorbed from the heavy metal remover. However, in the present invention, heavy metal ions adsorbed to the heavy metal remover can be desorbed from the heavy metal remover at a desired position. This may allow the heavy metal remover of the present invention to be regenerated to be reused, which is very excellent in an eco-friendly aspect.

The method for fabricating composite particles according to the present invention may be applied to composite particles having various functional groups, as well as the heavy metal remover of the present invention, by changing introduced materials. For instance, Au nanoparticles, CNTs, and silica are consecutively coated and calcined, thereby obtaining a multi core-silica shell structure where Au nanoparticles and CNTs have been mixed with each other.

According to another embodiment of the present invention, fabricated was a heavy metal remover including Au nanoparticles in a core. The heavy metal remover according to another embodiment was fabricated through the same processes as those in the aforementioned embodiment, except that Au nanoparticles were added to an aqueous solution of polymer template particles so is that the Au nanoparticles could be distributed on the surface of the template particles, and except that a shell consisted of silica.

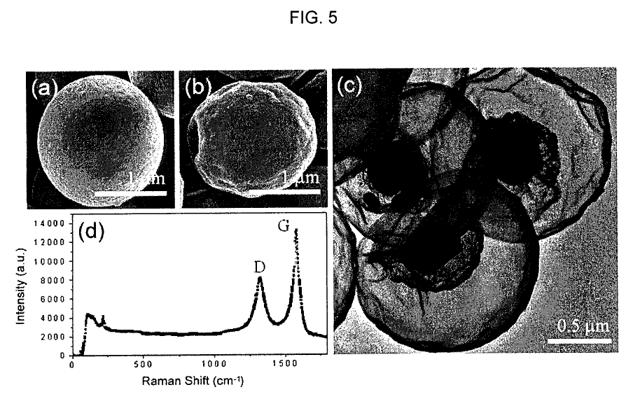

FIG. 5 shows electron microscope images of gold (Au)/CNTs composite core-silica shell according to each step, and Raman shifts of CNTs. FIG. 5(a) shows a scanning electron microscope (SEM) image of composite particles implemented as Au nanoparticles, CNTs, and PAH are sequentially coated, and FIG. 5(b) shows an image after heat-treatment. FIG. 5(c) shows a TEM image after heat-treatment, which illustrates a core consisting of Au nanoparticles and CNTs, and a silica shell. And, FIG. 5(d) show a Raman graph of a sample of which silica has been removed by acid treatment using fluorine, which illustrates ‘D’ and ‘G’ bands of the CNTs.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A heavy metal remover of a core-shell structure, the heavy metal remover comprising:
a core including carbon nanotubes that can aggregate and scatter in a reversible manner; and
a shell including iron oxide.

2. The heavy metal remover of claim 1, wherein the core further includes metallic particles.

3. The heavy metal remover of claim 1, wherein the metallic particles are at least one selected from a group consisting of gold, silver, platinum and copper.

4. The heavy metal remover of claim 1, wherein the shell has a multi-layered structure.

5. A method for fabricating a heavy metal remover of a core-shell structure, the method comprising:
(a) preparing a carbon nanotube (CNT) aqueous solution where acid-treated CNTs have dissolved;
(b) mixing the CNT aqueous solution with an aqueous solution of polymer template particles, thereby forming a CNT layer on a surface of the polymer template particles;
(c) mixing the solution having undergone the step (b) with a polymer electrolyte having positive charges, thereby forming a polymer layer on an outer surface of the CNT layer;
(d) adding FeSO₄, Fe₂(SO4)₃ or a mixture thereof to the solution having undergone the step (c), and stirring the solution, thereby including iron oxide in the polymer layer;
(e) separating particles from the solution having undergone the step (d); and
(f) removing the template particles by heat-treating the particles having been separated in the step (e).

6. A method for fabricating a heavy metal remover of a core-shell structure, the method comprising:
(a) preparing a carbon nanotube (CNT) aqueous solution where acid-treated CNTs have dissolved;
(b) mixing the CNT aqueous solution with an aqueous solution of polymer template particles, thereby forming a CNT layer on a surface of the polymer template particles;
(c) mixing the solution having undergone the step (b) with a polymer electrolyte having positive charges, thereby forming a polymer layer on an outer surface of the CNT layer;
(d) chemically processing the solution having undergone the step (c), thereby removing the template particles;
(e) adding FeSO₄, Fe₂(SO4)₃ or a mixture thereof to the solution having undergone the step (d), and stirring the solution, thereby including iron oxide in the polymer layer;
(f) separating particles from the solution having undergone the step (e).

7. The method of claim 5, before the step (b), further comprising (a′) adding metallic particles to the aqueous solution of polymer template particles, thereby distributing the metallic particles onto a surface of the polymer template particles.

8. The method of claim 5, wherein the polymer template particles are at least one selected from a group consisting of polystyrene, melamine formaldehyde, polymethyl methacrylate (PMMA) and silica.

9. The method of claim 5, wherein the polymer electrolyte having positive charges is at least one selected from a group consisting of poly(allylamine hydrochloride), polydiallyldimethylammonium chloride, and polyethylenimine.

10. The method of claim 5, wherein in step (b), the CNT layer is formed by electrostatic coupling between template particles in the template particle aqueous solution having positive charges and CNT particles in the CNT aqueous solution having negative charges.

11. The method of claim 5, wherein multi-layered polymer layers are formed by repeating the step (c).

12. The method of claim 5, wherein the heat-treatment in step (f) is performed at a temperature more than 500° C.

13. A method for removing heavy metal ions capable of removing heavy metal ions by adsorbing the heavy metal ions into CNTs of the core, with using the heavy metal remover of claim 1.

14. The method of claim 13, wherein the heavy metal remover having heavy metal ions adsorbed is separated from a solution by applying magnetic field.

15. The method of claim 13, wherein the heavy metal remover is reused by being regenerated through either mild acid treatment or sonication, or through both of the two processes for scattering aggregated CNTs of the core.

16. The method of claim 6, before the step (b), further comprising (a′) adding metallic particles to the aqueous solution of polymer template particles, thereby distributing the metallic particles onto a surface of the polymer template particles.

17. The method of claim 6, wherein the polymer template particles are at least one selected from a group consisting of polystyrene, melamine formaldehyde, polymethyl methacrylate (PMMA) and silica.

18. The method of claim 6, wherein the polymer electrolyte having positive charges is at least one selected from a group consisting of poly(allylamine hydrochloride), poly diallyldimethylammonium chloride, and polyethylenimine.

19. The method of claim 6, wherein in step (b), the CNT layer is formed by electrostatic coupling between template particles in the template particle aqueous solution having positive charges and CNT particles in the CNT aqueous solution having negative charges.

20. The method of claim 6, wherein multi-layered polymer layers are formed by repeating the step (c).
